(19) United States
(12) Patent Application Publication
(10) Pub. No.: US 2015/0095555 A1
(43) Pub. Date: Apr. 2, 2015

(54) METHOD OF THIN PROVISIONING IN A SOLID STATE DISK ARRAY

(71) Applicant: Avalanche Technology, Inc., Fremont, CA (US)

(72) Inventors: Mehdi Asnaashari, Danville, CA (US); Ruchirkumar D. Shah, San Jose, CA (US); Siamack Nemazie, Los Altos Hills, CA (US)

(73) Assignee: Avalanche Technology, Inc., Fremont, CA (US)

(21) Appl. No.: 14/171,234

(22) Filed: Feb. 3, 2014

Related U.S. Application Data
(63) Continuation-in-part of application No. 14/040,280, filed on Sep. 27, 2013, now Pat. No. 8,954,657.
Application No. 14/040,280 is a continuation-in-part of application No. 14/050,274, filed on Oct. 9, 2013.
Application No. 14/050,274 is a continuation-in-part of application No. 14/073,669, filed on Nov. 6, 2013.

(51) Int. Cl. G06F 3/06

(52) U.S. Cl. CPC G06F 3/0665; G06F 3/0688; G06F 3/0689; G06F 3/0619
USPC 711/103; 711/114

(57) ABSTRACT

A method of thin provisioning in a storage system is disclosed. The method includes communicating to a user a capacity of a virtual storage, the virtual storage capacity being substantially larger than that of a storage pool. Further, the method includes assigning portions of the storage pool to logical unit number (LUN) logical block address (LBA)-groups only when the LUN LBA-groups are being written to and maintaining a mapping table to track the association of the LUN LBA-groups to the storage pool.

### CROSS-REFERENCE TO RELATED APPLICATIONS

This application is a continuation-in-part of U.S. patent application Ser. No. 14/040,280, filed Sep. 27, 2013, by Mehdi Asnaashari, entitled “STORAGE PROCESSOR MANAGING SOLID STATE DISK ARRAY” and is a continuation-in-part of U.S. patent application Ser. No. 14/050,274, filed Oct. 9, 2013, by Mehdi Asnaashari, entitled “STORAGE PROCESSOR MANAGING NVME LOGICALLY ADDRESSED SOLID STATE DISK ARRAY” and a continuation-in-part of U.S. patent application Ser. No. 14/073,669, filed Nov. 6, 2013, by Mehdi Asnaashari, entitled “STORAGE PROCESSOR MANAGING SOLID STATE DISK ARRAY”.

### BACKGROUND OF THE INVENTION

1. Field of the Invention

This invention relates generally to solid state disks and particularly to usage schemes employed by solid state disks.

2. Description of the Prior Art

With the advent of the popularity of solid state drives (SSDs) and exponential growth of network content, the emergence of all-flash storage systems, such as SSD arrays or storage appliances, has been realized. These systems or appliances are mostly network attached storage (NAS) or storage attached network (SAN) with high-speed and high bandwidth network such as a 10 Giga bit Ethernet (10 GbE). These storage units typically include arrays of one or more SSDs to meet capacity and performance requirements.

Blocks of data, to be written or read, are typically associated with a logical block address (LBA) from a host that uses the SSDs to store and/or read information. SSDs are physical storage spaces that are obviously costly and take up real estate. In systems using many storage appliances or arguably even one storage appliance, these costs and real estate hits are highly undesirable to users of these systems, i.e. manufacturers.

The concept of thin provisioning, known to those in the art, has been gaining ground because it leaves a host of a storage system that is in communication with the storage appliance with the impression that the physical or actual storage space, i.e. SSD, is larger than it oftentimes actually is. One might wonder how the system can effectively operate with less storage space than that which is called out by the host. It turns out that the space communicated from the host to the storage appliance is not always the entire space that is actually to be used for storage, in fact most often, a fraction of this space is actually utilized. For example, a user might think it needs 10 Giga Bytes and therefor requests such a capacity. In actuality however, it is far unlikely that the user stores data in all of the 10 Giga Bytes of space. On occasion, the user might do so, but commonly, this is not done. Thin provisioning takes advantage of such apriory knowledge to assign SSD space only when data is about to be written rather than when storage space is initially requested by the host.

However, thin provisioning is tricky to implement. For example, it is not at all clear how the host's expectation of space size that has been misrepresented can be managed with SSD that has considerably less storage space than that which the host has been led to believe. This is clearly a complex problem.

Thus, there is a need for a storage system using thin provisioning to reduce cost and physical storage requirements.

### SUMMARY OF THE INVENTION

Briefly, a method of thin provisioning in a storage system includes communicating to a user a capacity of a virtual storage, the virtual storage capacity being substantially larger than that of a storage pool. Further, the method includes assigning portions of the storage pool to logical unit number (LUN) logical block address (LBA)-groups only when the LUN LBA-groups are being written to and maintaining a mapping table to track the association of the LUN LBA-groups to the storage pool.

These and other objects and advantages of the invention will no doubt become apparent to those skilled in the art after having read the following detailed description of the various embodiments illustrated in the several figures of the drawing.

### IN THE DRAWINGS

FIG. 1 shows, a storage system (or “appliance”) 8, in accordance with an embodiment of the invention.

FIG. 2 shows LUN table pointer 200, virtual storage mapping tables 202, and storage pool 212.

FIG. 2a shows a virtual storage 214, virtual storage mapping tables 202, and storage pool 212.

FIG. 3 shows an example 300 of a storage pool free LBA-group queue 300, typically constructed during the initial installation of the storage pool 26.

FIG. 4 shows an example of the storage pool free LBA-group bit map 400 consistent with the example of FIG. 3.

FIG. 5 shows LUN table pointer and LUNs mapping table for the example of FIGS. 3 and 4.

FIG. 6 shows exemplary tables 600, in accordance with another method and apparatus of the invention.

FIG. 7 shows an example of table 700 including an allocation table pointer.

FIG. 8 shows exemplary tables 800, analogous to the tables 600 except that the tables 800 also include an allocation table.

FIGS. 9-13 each show a flow chart of a process performed by the CPU subsystem 14, in accordance with methods of the invention.

### DETAILED DESCRIPTION OF THE VARIOUS EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the invention. It should be noted that the figures discussed herein are not drawn to scale and thicknesses of lines are not indicative of actual sizes.

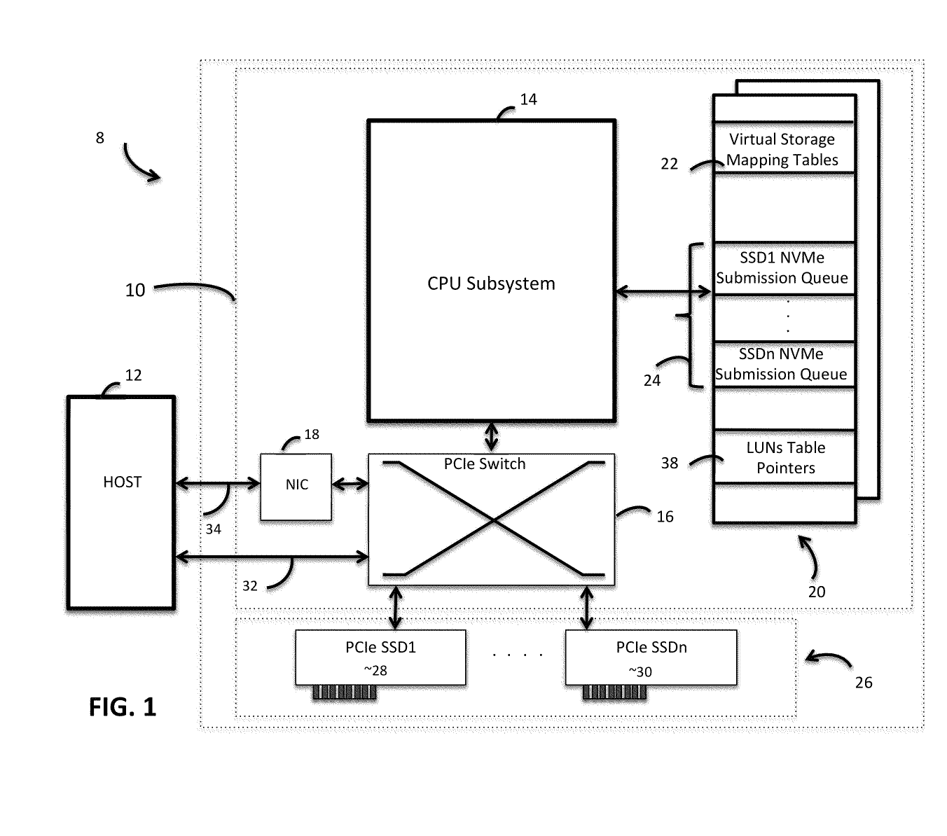

Referring now to FIG. 1, a storage system (or “appliance”) 8 is shown in accordance with an embodiment of the invention. The storage system 8 is shown to include storage processor 10 and a storage pool 26, the storage pool 26 including bank of solid state drives (SSDs) 28-30. The storage system 8 is shown coupled to a host 12. In an embodiment of the invention, the storage pool 26 of the storage system 8 are each a Peripheral Component Interconnect Express (PCIe) solid state disks (SSD), herein thereafter referred to as PCIe SSD.

The storage processor 10 is shown to include a CPU subsystem 14, a PCIe switch 16, a network interface card (NIC) 18, and memory 20. The memory 20 is shown to include virtual storage mapping tables (or “L2sL tables”) 22, SSD non-volatile memory express (NVMe) submission queues 24, and LUN table pointers 38. The storage processor 10 is further shown to include an interface 34 and an interface 32.

The host 12 is shown coupled to the NIC 18 through the interface 34 and is optionally coupled to the PCIe switch 16 through the interface 32. The PCIe switch 16 is shown coupled to the storage pool 26. The storage pool 26 is shown to include ‘n’ number of PCIe SSDs; PCIe SSD1 28 through PCIe SSDn 30, with the understanding that the storage pool 26 may have additional SSDs than that which is shown in the embodiment of FIG. 1. ‘n’ is an integer value. The PCIe switch 16 is further shown coupled to the NIC 18 and the CPU subsystem 14. The CPU subsystem 14 is shown coupled to the memory 20. It is understood that the memory 20 may and typically does store additional information, not depicted in FIG. 1.

In an embodiment of the invention, parts or all of the memory 20 is volatile, such as, without limitation, dynamic random access memory (DRAM). In other embodiments, part or all of the memory 20 is non-volatile, such as and without limitation flash, magnetic random access memory (MRAM), spin transfer torque magnetic random access memory (STTMRAM), resistive random access memory (RRAM), or phase change memory (PCM). In still other embodiments, the memory 20 is made of both volatile and non-volatile memory.

It is desirable to save the mapping tables 22 and the table pointers 38 in non-volatile memory of the memory 20 so as to maintain the information saved therein even when power is not applied to the memory 20. As will be evident shortly, maintaining the information in memory at all times is of particular importance because the information maintained in the tables 22 and 38 is needed for proper operation of the storage system subsequent to a power interruption.

During operation, the host 12 issues a read or a write command, along with data in the case of the latter. Information from the host is normally transferred between the host 12 and the processor 10 through the interfaces 32 and/or 34. For example, information is transferred through the interface 34 between the processor 10 and the NIC 18. Information between the host 12 and the PCIe switch 16 is transferred using the interface 34 and under the direction of the of the CPU subsystem 14.

In the case where data is to be stored, i.e. a write operation is consummated, the CPU subsystem 14 receives the write command and accompanying data, for storage, from the host through the PCIe switch 16, under the direction of the CPU subsystem 14. The received data is ultimately saved in the memory 20. The host write command typically includes a starting LBA and the number of LBAs (sector count) that the host intends to write to as well as the LUN. The starting LBA in combination with sector count is referred to herein as “host LBAs” or “host provided LBAs”. The storage processor 10 or the CPU subsystem 14 maps the host-provided LBAs to portion of the storage pool 26.

In the discussions and figures herein, it is understood that the CPU subsystem 14 executes code (or “software program(s)”) to perform the various tasks discussed. It is contemplated that the same may be done using dedicated hardware or other hardware and/or software-related means.

Capacity growth of the storage pool 26, employed in the storage system 8, renders the storage system 8 suitable for additional applications, such as without limitation, network attached storage (NAS) or storage attached network (SAN) applications that support many logical unit numbers (LUNs) associated with various users. The users initially create LUNs with different sizes and portions of the storage pool 26 are allocated to each of the LUNs.

To optimize the utilization of the available storage pool 26, the storage appliance 8 employs virtual technology to give the appearance of having more physical resources than are actually available. This is referred to as thin provisioning. Thin provisioning relies on on-demand allocation of blocks of data to the LUN versus the traditional method of allocating all the blocks up front when the LUNs are created. Thin provisioning allows system administrators to grow their storage infrastructure gradually on an as-need basis in order to keep their storage space budget in control and only buy storage when it is actually and immediately needed. LUNs, when first created or anytime soon thereafter, do not utilize their capacity in their entirety and for the most part, some of their capacity remains unused. As such, allocating portions of the storage pool 26 to the LUNs per demand optimizes the storage pool utilization. Storage appliance or storage system employing virtual technology typically communicates or reports a virtual capacity (also referred to as “virtual storage” or “virtual space”) to user(s), such as one or more hosts.

In an embodiment of the invention, when LUNs are first created, storage processor 10 allocates portions of a virtual space (or virtual storage 214) as opposed as to allocating portions of a physical space from the storage pool 26. Capacity of the virtual storage 214 is substantially larger than that of the storage pool 26; typically anywhere from 5 to 10 times the size of the storage pool 26. For the storage processor 10 to accommodate the capacity of the virtual storage 214, it should have enough resources, i.e. memory 20, to support the virtual storage mapping tables 22. Portions of the storage pool 26 are assigned, by the storage processor 10, to the LUNs as the LUNs are being utilized; such as being written to, on an as needed or required basis. When utilization of the storage pool 26 approaches a predetermined threshold, an action is required to either increase the size of the storage pool 26 or to move or migrate some of the LUNs to another storage system.

In some embodiments of the invention, the storage processor 10 further tracks the total size for all the LUNs and compares it against the virtual storage size and aborts a LUN creation or LUN enlargement process when the total size of all the LUNs grows to be larger than the virtual storage size. The storage system 8 only has enough resources to support the virtual storage size. The storage appliance further will allow only certain number of LUNs to be created on the storage system and any LUN creation process beyond that will result in the process being aborted.

To easily accommodate LUN resizing and avoid the challenges and difficulties associated therewith, LUNs are maintained at some granularity and divided into units of the size of the granularity, the unit is referred to herein as LUN LBA-group.

LUNs can only to be created or resized at LUN LBA-group granularity. Portions of the storage pool 26 allocated or assigned to each LUN are also at the same LBA-group granularity. The mapping tables 22 of FIG. 1 are managed by the storage processor 10 and maintain the relationship between the portions of the physical storage pool 26 (referred herein as ‘storage pool LBA-groups’) and LUN LBA-groups for each LUN in the storage system. Storage processor 10 identifies one or more storage pool LBA-groups being accessed for the first time (assigned) or removed (unassigned) and updates the mapping tables 22 accordingly.

The users initially create one or more LUNs of different sizes, but the storage processor 10 does not assign any portions of the storage pool 26 to the LUNs at the time they are created. The storage system 8 specifies the virtual size, number of LUNs, and maximum size of the LUN. At the time of receiving a request to create a LUN, the storage processor 10 first verifies that the number of LUNs does not exceed the maximum number of LUNs allowed by the storage system. It also verifies the total size of LUNs to not exceed the virtual storage size of the storage system 8. In the event that the number of LUNs is higher than the total number of LUNs allowed by the storage processor or the total size of all the LUNs exceeds the virtual storage size of the storage processor, the storage processor notifies the user and aborts the process. Otherwise, it creates mapping tables for each of one or more LUNs in the memory 20 and updates the mapping table pointer entries with starting locations of the mapping tables. The storage processor 10 at this point does not allocate any portions of the storage pool 26 to the LUNs. Once the user tries to access a LUN, the storage processor identifies the LBA-groups being accessed and only then allocates portions of the storage pool 26 to each LBA-group of the LUN being accessed. The storage processor stores and maintains these relationships between the storage pool LBA-groups and LUN LBA-groups in the mapping table 22.

In one embodiment of the invention, upon subsequent accesses of the LUN LBA-groups that have already been associated with storage pool LBA-groups, the storage processor identifies the LUN LBA-groups as previously accessed LBA-groups and uses their associated storage pool LBA-group for further accesses.

The user may also want to increase or decrease the size of its LUN based on the users' needs and applications. Furthermore, the user may decide there is no longer a need for the entire storage or would like to move (migrate) its storage to another storage appliance that better fits its application and input/output (I/O) requirements.

In the case where a LUN is being increased in size, the storage processor 10 checks to ensure that the added size does not outgrow the total virtual storage size. The mapping table for the LUN was already generated when the LUN was first created. The storage processor 10 does not allocate any portion of the storage pool 26 to the LUN.

In the case where a LUN is being decreased in size, the storage processor 10 first identifies the effected LBA-groups and checks the mapping table to determine whether the effected LBA-groups have already been assigned to portions of the storage pool 26. The storage processor then disassociates the portions of the storage pool 26 that are associated with any of the affected LBA-groups. Affected LBA-groups are LBA-groups that have already been assigned to the storage pool 26. Disassociation is done by updating the mapping table associated with the LUN and returning the portions of the storage pool that are no longer needed for storage by the user to a storage pool free list. Storage pool free list is a list of storage pool LBA-groups that are available to be assigned.

In the case where a LUN is being migrated or deleted, the storage processor 10 performs the same step as when a LUN is being decreased in size with the exception that it also de-allocates the memory 20 associated with the mapping table and removes the entry in the LUN table pointer.

The storage pool LBA-group mapping to LUN LBA-group by the storage processor 10 is better explained by use of examples cited below. It is worth noting that this mapping scheme allows per demand growth of the SSD storage space allocated to a user. This process advantageously allows the storage system to not only manage the LUNs in a multi-user setting but to also allow for efficient and effective use of the storage pool 26. Efficiency and effective use is increased by avoiding moving data to a temporary location and re-mapping and moving the data back, as done by prior art methods.

In cases where host LBAs associated with a command span across more than one LUN LBA-group, the command is broken up into sub-commands at a LBA-group boundary with each sub-command having a distinct LUN LBA-group.

In summary, the storage appliance 8 performs thin provisioning by communicating, to a user, the capacity of the virtual storage 214 that is often times substantially larger than the capacity of the storage pool 26 to the host 12. This communication is most often done during initial setup of the storage system. At this point, the host 12 may very well be under the impression that the storage pool 26 has a greater capacity than it the storage system 8 physically has because the capacity being communicated to the host is virtual. Host 8 uses the virtual capacity for allocating storage to the LUNs and the storage processor 10 tracks the actual usage of the storage pool 26. Storage processor 10 assigns portions of the storage pool 26 to LUN LBA-groups but only when the LUN LBA-groups are being written to by the host 12. A mapping table is maintained to track the association of the LUN LBA-groups to the storage pool 26.

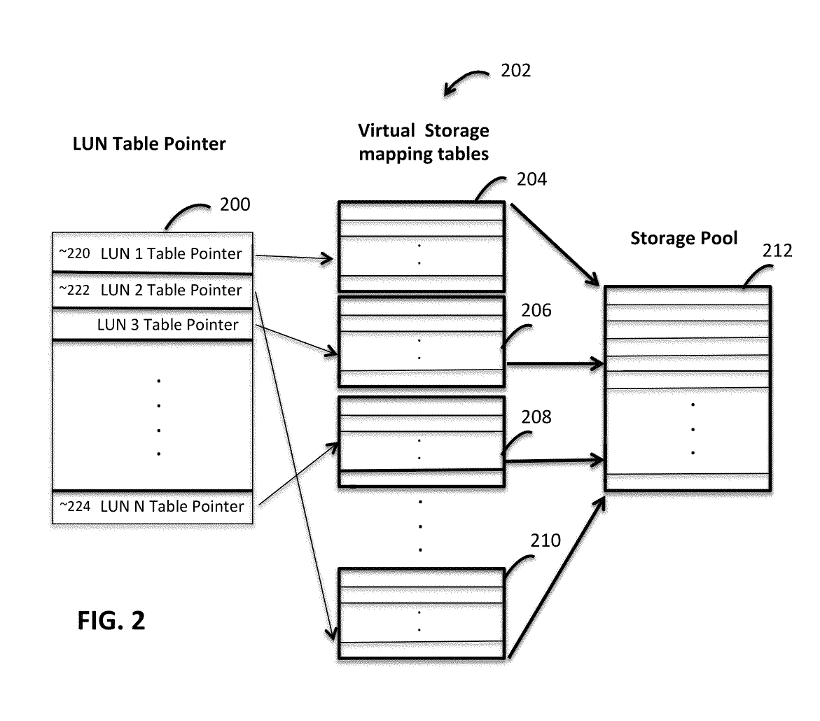

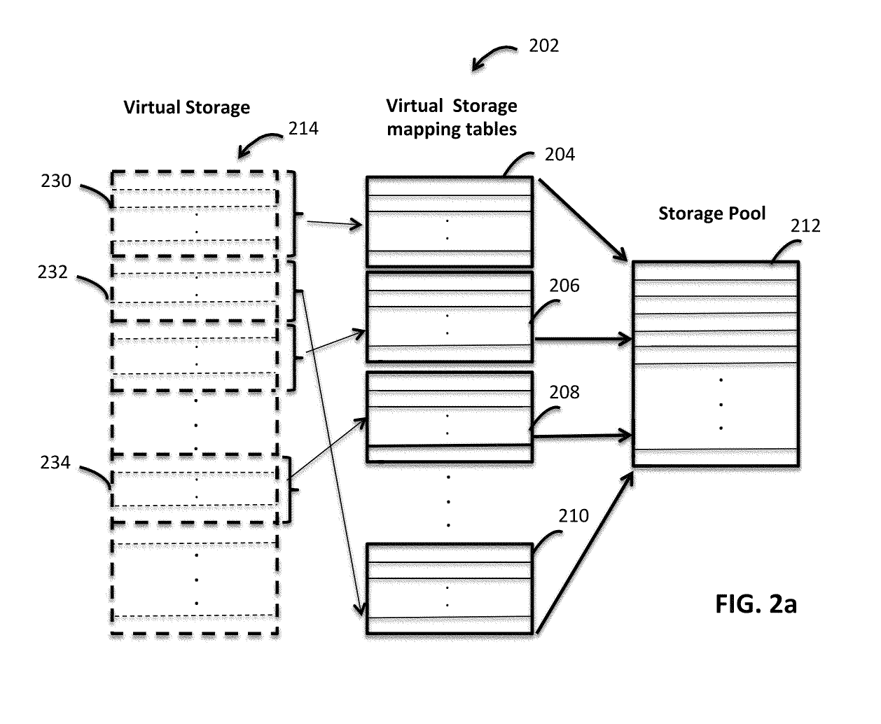

FIG. 2 shows exemplary tables, in accordance with an embodiment of the invention. In FIG. 2, the LUN table pointer 200, virtual storage mapping tables 202, and storage pool 212 are shown. Storage pool 212 is analogous to storage pool 26 and LUN table pointer 200 is analogous to LUNs table pointers 38 of FIG. 1. The table 200 is shown to include LUN table pointers with each entry pointing to a starting location of a mapping table for each LUN within the memory 20. For example, LUN 1 table pointer 220 of the LUN table pointer 200 points to a starting location within the memory 20 where the mapping table 204 associated with LUN 1 is located. That is, the virtual storage mapping tables 202, which is a part of the memory 20 includes a number of mapping tables, some of which are shown in FIG. 2 to be mapping tables 204, 206, 208, and 210. Each of the entries of the LUN table pointer 200 corresponds to a distinct mapping table of the virtual storage mapping tables 202. For example, as noted above, LUN 1 table pointer 220 of the LUN table pointer 200 corresponds to LUN 1 mapping table 204, LUN 2 table pointer 222 of the LUN table pointer 200 corresponds to mapping table 206 and LUN N table pointer 224 of the LUN table pointer 200 corresponds to mapping table 208. The correspondence of the LUNs of pointer 200 to the mapping tables of virtual storage mapping tables 202 are not in order, as noted and shown herein. Also, the mapping tables of the virtual storage mapping tables 202 need not and are typically not contiguous. Storage processor 10 allocates the portion of the memory 20 that is available at the time for a mapping table when the LUN is first created. LUNs are created at different times by the host 12 and they are typically not created in any particular order. As such, the mapping tables 204 through 210 may be scattered all over the memory 20 with table pointer 200 identifying their locations.

The storage processor 10 should have enough memory resources in memory 20 to support the maximum size of virtual storage mapping tables 202 which corresponds to the maximum number of LUNs allowed in the storage appliance 8. Size of the virtual storage mapping tables 202 increases as more number of LUNs are created in the storage system 8.

Each entry/row of the mapping tables of the virtual storage mapping table 202 has the potential of being associated with a storage pool LBA-group in the storage pool 212. In a thin provisioned storage system, all entries of the virtual storage mapping tables 202 cannot be associated with the storage pool 212 when number of the number of entries in the virtual storage mapping table 202 exceeds the storage pool LBA-groups. This is a characteristic of thin provisioning. As LUNs are created, the number of virtual storage mapping tables 202 increases and upon the size of the virtual storage mapping tables 202 outgrowing the size of the storage pool 212, there is no longer a one-to-one correspondence between the assignment of the virtual storage mapping tables 204 to the storage pool.

The storage processor 10 keeps track of the portion of the virtual storage 214 that has not been allocated. When a new LUN is created, storage processor 10 verifies that the size of the LUN being created is less or equal to the portion of the virtual storage 214 that has not been allocated otherwise it aborts the process. The storage processor 10 then allocates a portion of memory 20 for mapping table (such as the mapping table 204, 206, 208, and 210) and associates it with the particular LUN and updates the LUN table pointer entry associated with the LUN with the starting location of the mapping table 204. The storage processor 10, at this point, does not allocate any portion of the storage pool 212 to the LUN and as such, all the entries of the mapping table 204 are “Null”. A “Null” entry in the mapping table signifies that the LUN LBA-group corresponding to the Null entry has not yet been mapped to any portion of the storage pool 26.

In an embodiment of the invention, the number of rows or entries of the mapping table 204 depends on the maximum number of LBA-groups that the storage processor 10 has to store and maintain for a LUN and is further based on the maximum size of the LUN allowed by the storage system 8 and the size of the LUN LBA-groups.

In some embodiment of the invention, to reduce the memory required to maintain the virtual storage mapping tables 202 that comprises the mapping tables, the size of the mapping table may be based on the actual size of the LUN being created. If the LUN grows in size with time, the storage processor 10 may then allocate a larger memory space for the LUN to accommodate the LUN in its entirety, move the content of the previous mapping table to a new mapping table, and update the mapping table starting address in the mapping table pointer accordingly.

In another embodiment of the invention, storage processor 10 may create a second mapping table when a LUN grows in size where the second mapping table has enough entries to accommodate the growth in the size of the LUN. In this case, the first and second mapping tables are linked together.

The contents of each of the rows of the virtual storage mapping tables 202 is either a storage pool LBA-group number identifying the location of the LBAs in the SSDs or storage pool 26 or a “Null” entry signifying that the LUN LBA-group corresponding has not yet been mapped to any portion of the storage pool 26

The virtual storage mapping tables 202 may reside in the memory 20. In some embodiments of the invention, these tables may reside in the non-volatile portion of the memory 20.

FIG. 2a shows the virtual storage 214. It is shown in dashed lines since it only exist virtually. In some embodiment, the virtual storage 214 is just a value that is first set by the storage system. The capacity of the virtual storage 214 is used to in the storage system to determine the maximum size of the virtual storage mapping tables 202 and portion of the memory 20 required to maintain these tables. As LUNs are created, resized, deleted or migrated, the storage processor allocates or de-allocates portions of the virtual storage and tracks a tally of the unallocated portion of the virtual storage 214.

As shown in FIG. 2a, when a LUN is created, portion of the virtual storage 214; such as 230, 232, and 234 is allocated to the LUN and assignment of the LUN LBA-groups to the storage pool 26 is stored and maintained in the virtual storage mapping tables 202. When a LUN is created, the storage processor subtracts the size of the LUN from the tally that tracks the unallocated portion of the virtual storage 214.

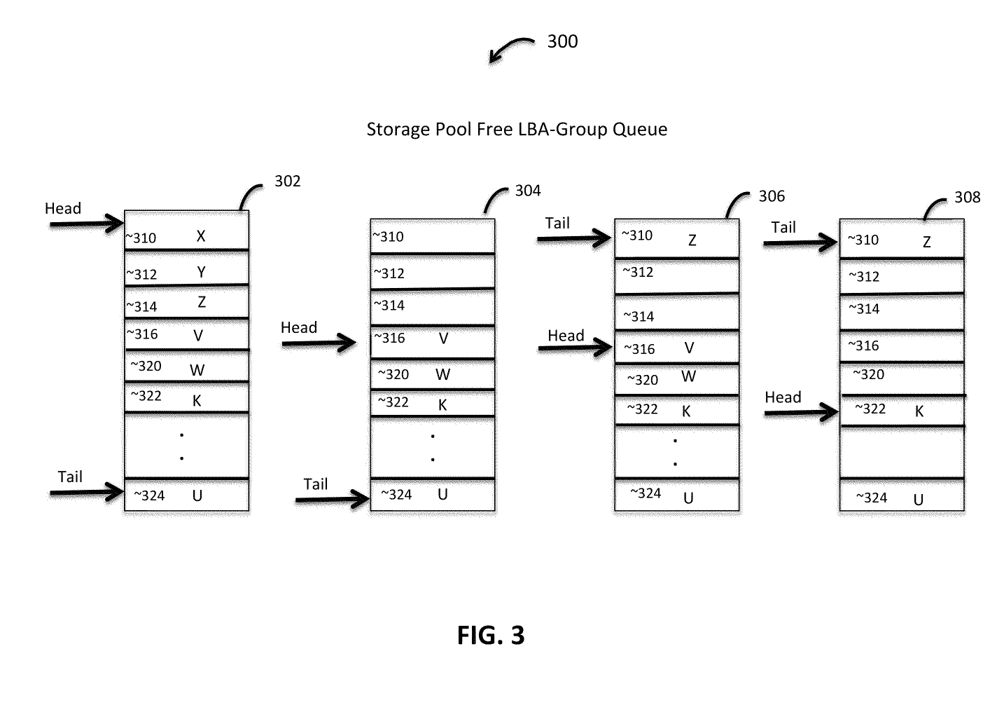

FIG. 3 shows an example 300 of a storage pool free LBA-group queue 302, typically constructed during the initial installation of the storage appliance and storage pool 26. The storage processor 10 maintains a list of free LBA-groups within the storage pool 26 (also herein referred to as “storage pool free list”) in the storage pool free LBA-group queue 302. In an embodiment of the invention, the queue 302 is stored in the memory 20.

The storage pool LBA-groups are portions of the physical storage (not virtual) pool within the storage system at a granularity of the LBA-group size. The storage pool free LBA-group queues 302-308 shows the same table with its contents changing at table 304-308 at different stages, going from the left side of the page to the right side of the page. The queue 302 is shown to have a head pointer and a tail pointer and each row, such as rows 310-324, includes a free list LBA-group for a particular LUN. For example, in the row 310, the LBA-group ‘X’ is unassigned or free. When one or more LUN LBA-groups are being accessed for the first time, the storage processor 10 assigns one or more LBA-groups from the storage pool free LBA-group queue 300 to the one or more LUN LBA-groups being accessed and adjusts the queue head pointer accordingly. Every time one or more storage pool LBA-groups are disassociated with LUN LBA-groups, those storage pool LBA-groups become available or free, and will be added to the free list by being adding to the tail of the queue 302, 304, 306, or 308.

In the example 300, initially, all the storage pool LBA-groups ‘X’, ‘Y’, ‘Z’, ‘V’, ‘W’, ‘K’, and ‘U’ are available or free and are part of the storage pool free list as shown by the queue 302. Thus, the head pointer points to the LBA-group ‘X’ 310, which is the first storage pool LBA-group in the table 302, and the tail pointer points to the last LBA-group, LBA-group ‘U’ 324.

Next, at the queue 304, three storage pool LBA-groups are being requested by the storage processor 10 due to a one or more LUNs being accessed for the first time. Thus, three storage pool LBA-groups from the free list become no longer available or free. The head pointer accordingly, moves down three rows to the row 316 pointing to the next storage pool free LBA-group ‘V’ 316 and the rows 310-314 no longer have available or free LBA-groups. Subsequently, at the queue 306, the LBA-group ‘Z’ 310 becomes free (unassigned or disassociated from a LUN LBA-group) due to LUN reduction in size, or LUN deletion or migration. Storage processor 10 identifies LBA-group ‘Z’ as having already been associated with a storage pool LBA-group and as such, it will disassociate the LUN LBA-group from the storage pool LBA-group. Accordingly, the tail pointer moves up by one row to point to the row 310 and storage pool LUN-group ‘Z’ 310 is saved at the tail of the queue 306. Finally, at 308, two more LBA-groups are requested, thus, the head pointer moves down by two rows, from the row 316, to the row 322 and the tail pointer remains in the same location. The LBA-groups ‘V’ 316 and ‘W’ 320 are thus no longer available.

The same information, i.e. maintaining the free list may be conveyed in a different fashion, such as using a bit map. The bit map maps the storage pool LBA-groups to bits with each spatially representing a LBA-group.

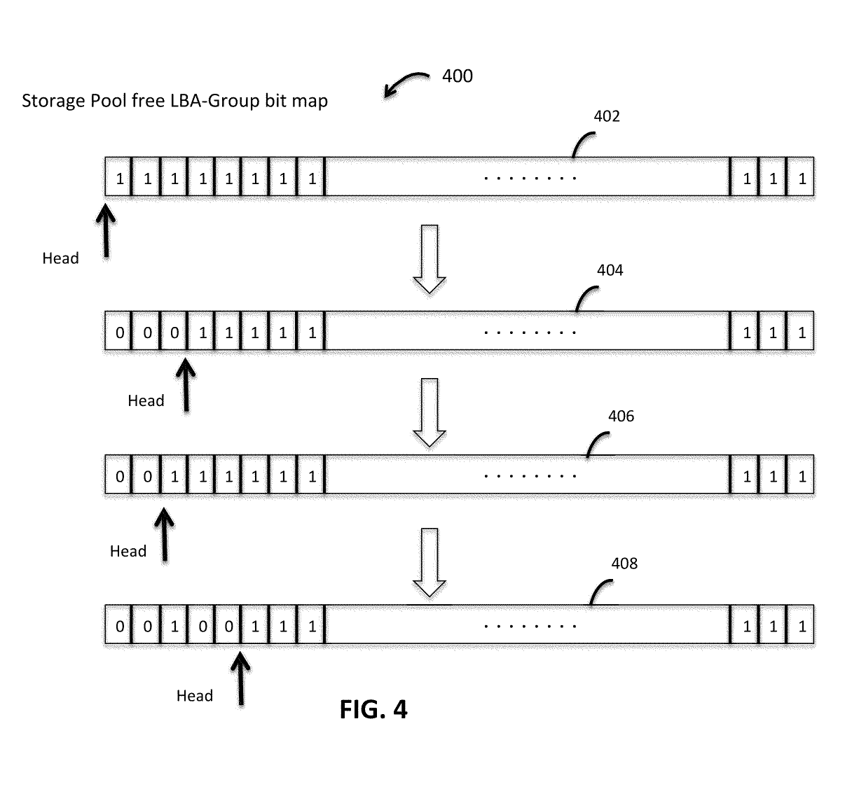

FIG. 4 shows an example of the storage pool free LBA-group bit map 400 consistent with the example of FIG. 3. Storage processor 10 uses the bit map 400 to maintain the storage pool free list. Bit maps 402-408 are the same bit map but at different stages with the first stage shown by the bit map 402 and the last stage shown by the bit map 408. Each bit of the bit maps 402-408 represents the state of a particular LBA-group within the storage pool 26 as it relates to the availability of the LBA-group.

At the bit map 402, all of the storage pool LBA-groups are free, as also indicated at the start of queue 302. The head pointer points to the first bit of the bit map 402. A logical state of ‘1’ in the example of 400 of FIG. 4 represents an available or free storage pool LBA-group whereas a logical state ‘0’ represents unavailability of the storage pool LBA-group. It is contemplated that a different logical state representation may be employed. The bit map 400 therefore shows availability, or not, of a storage pool LBA-group in a certain position and not the storage pool LBA-group itself, as done by the queue 302. For instance, the storage pool LBA-group ‘X’ is not known to be anywhere in the bit map 400 but its availability status is known.

At the bit map 404, three free storage pool LBA-groups from the storage pool 26 are assigned to one or more LUNs and are no longer free. Accordingly, the head pointer moves three bit locations to the right and bits associated with the assigned storage pool LBA groups are changed from state ‘1’ to state ‘0’ indicating that those LBA-groups are no longer free. Next, at the bit map 406, one storage pool LBA-group becomes free and its bit position is changed to a logical state ‘1’ from the logical state ‘0’. Next, at bit map 408, two storage pool LBA-groups are requested by the storage processor 10, thus, the next two free storage pool LBA-groups from the storage pool 26 gets assigned and the head pointer is moved two bit locations to the right with the two bits indicating unavailability of their respective storage pool LBA-groups. In one implementation of the invention, the head pointer only moves when L storage pool BA-groups are being assigned and become unavailable and not when storage pool LBA-groups are added in an attempt to assign the storage pool LBA-groups evenly. It is contemplated that different schemes for assigning storage pool LBA-groups from a bit map may be employed.

The queue 302 of FIG. 3 or the bit map 400 of FIG. 4 are two of many schemes that can be used by the storage processor 10 to readily access the free list. The storage pool free list is used to identify free storage pool LBA-groups when storage pool LBA-groups are being added to LUNs and the identified storage pool LBA-groups are removed from the storage pool free list. The identified storage pool LBA-groups are associated with the added LBA-groups in the LUN mapping table by adding the identified storage pool LBA-groups to the mapping table 204 which is indexed by the LBA-groups being added to the LUN. When LBA-groups are being removed from a LUN, the storage pool LBA-groups associated with the LUN LBA-groups are identified and disassociated (or unassigned) from the LUN mapping table 204 by removing the storage pool LBA-groups being removed from the mapping table and adding them to the storage pool free list.

The queue 302 of FIG. 3 and/or the bit map 400 of FIG. 4 may be saved in the memory 20, in an embodiment of the invention. In some embodiments, they are saved in the non-volatile part of the memory 20.

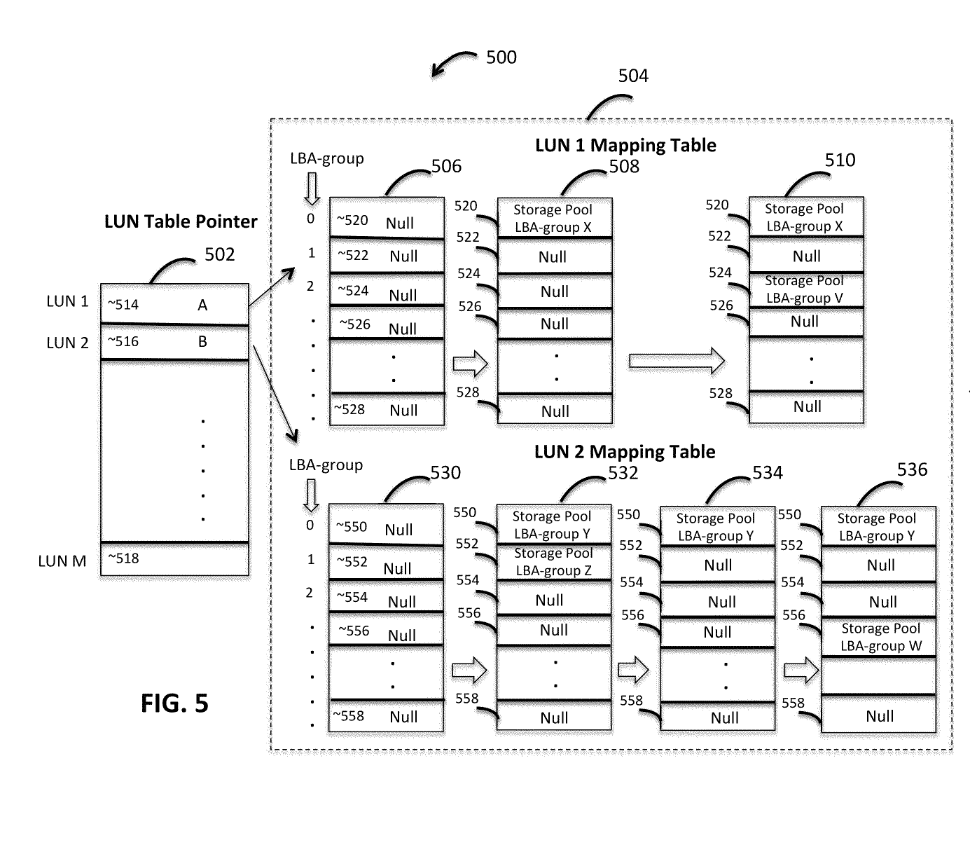

FIG. 5 shows an example 500 of the pointers and tables of the storage processor 10, in accordance with an embodiment of the invention. The example 500 includes a LUN table pointer 502 and LUNs mapping tables 504, which both follow the example of FIGS. 3 and 4. In FIG. 5, the LUN table pointer 502 is analogous to the table 202 of FIG. 2 and each of the tables of the LUN mapping tables 504 is analogous to the table 204 of FIG. 2. Each entry of the LUN table pointer 502 points to the starting location of a particular LUN mapping table in the memory 20. For example, ‘A’ in the first row 514 of the table 502, which is associated with LUN 1 points to the starting location of LUN 1 mapping table 506 and ‘B’ in the row 516 of the table 502, associated with LUN 2, points to the starting location of LUN 2 in the mapping table 530. In this example, LUN 1 and LUN 2 have been created and storage processor 10 has created their respective mapping tables 506 and 530. All the entries of the two mapping tables 506 and 530 are ‘Null’ which signifies that LUNs have not yet been accessed and therefore no storage pool LBA-group has yet been assigned to these LUNs.

Using the example of FIGS. 3 and 4, due to a write command to LUN 1, the storage processor 10 calculates the number of LBA-groups being written to, based on the size of the write command and the size of the LBA-group, and determines that LBA-group 0 is being written for the first time. Storage pool LBA-group ‘X’ is then assigned to LUN 1 LBA-group 0 from the storage pool free list. Entry 520 of the LUN 1 mapping table 506 is updated with ‘X’ and the table 506 transitions to table 508 with the rest of the rows of the table 508 having a ‘Null’ value as their entries signifying the LUN 1 LBA-groups that have not been written to nor have been assigned a LBA-group from the storage pool 26. Then, due to write command to the LUN 2 and calculation of the number of LBA-groups being written to, the storage processor 10 determines two LBA-groups 0 and 1 are being written to. Free storage pool LBA-groups ‘Y’ and ‘Z’ are assigned to LUN 2 LBA-group 0 and 1, respectively, from the storage pool free list. Entries 550 and 552 of LUN 2 of the mapping table 530 are updated with ‘Y’ and ‘Z’ and table 530 transitions to table 532 with the rest of the rows of the table 532 having a ‘Null’ value signifying the LUN 2 LBA-groups that are have not been written to nor have been assigned LBA-group from the storage pool 26.

Next, due to a LUN 2 resizing process, storage processor 10 determines that LUN 2 is releasing LBA-group 1 and therefore the storage pool LBA-group ‘Z’ associated with LUN1 LBA-group is put back into the storage pool free list by adding it to the tail of storage pool free LBA-groups queue, for example one of the queues 302-308. Namely, the storage pool LBA-group ‘Z’ is removed from row 552 of table 532 and instead this row is indicated as not being assigned or having a ‘Null’ value. LUN 2 mapping table 532 transitions to table 534.

Next, to continue the example above, LBA-group 2 in LUN1 is written to. Since this LBA-group is being written to for the first time, storage processor 10 requests one free LBA-groups from the storage pool 26. One free LBA-groups, i.e. LBA-groups ‘V’ from the storage pool free list is identified and assigned to LUN 1 LBA-group 2 and the LUN 1 mapping table 508 is updated accordingly by the LUN LBA-group 2 524 having a value of ‘V’. Mapping table 508 transitions to table 510.

Next, LBA-group 3 in LUN 2 is written to. Since this LBA-group is being written to for the first time, storage processor 10 requests one free LBA-groups from the storage pool 26. One free LBA-groups, i.e. LBA-groups ‘W’, from the storage pool free list is identified and assigned to LUN 2 LBA-group 3 and the LUN 2 mapping table 534 is updated accordingly with the LUN LBA-group 3 556 having a value of ‘W’. Mapping table 534 transitions to table 536.

The LBA-group granularity is typically determined by the smallest chunk of LBAs from the storage pool 26 that can be allocated to a LUN. For example, if users are assigned 5 GB at a given time and no less than 5 GB, the LBA-group granularity is 5 GB. All assignment of space to the users would have to be in 5 GB increments. If only one such space is allocated to a LUN, the number LBA-group from the storage pool would be one and the size of the LUN would be 5 GB. As will be discussed later, the size of the mapping tables hence the amount of memory in the memory 20 that is being allocated to maintain these tables is directly related to the size/granularity of the LBA-groups.

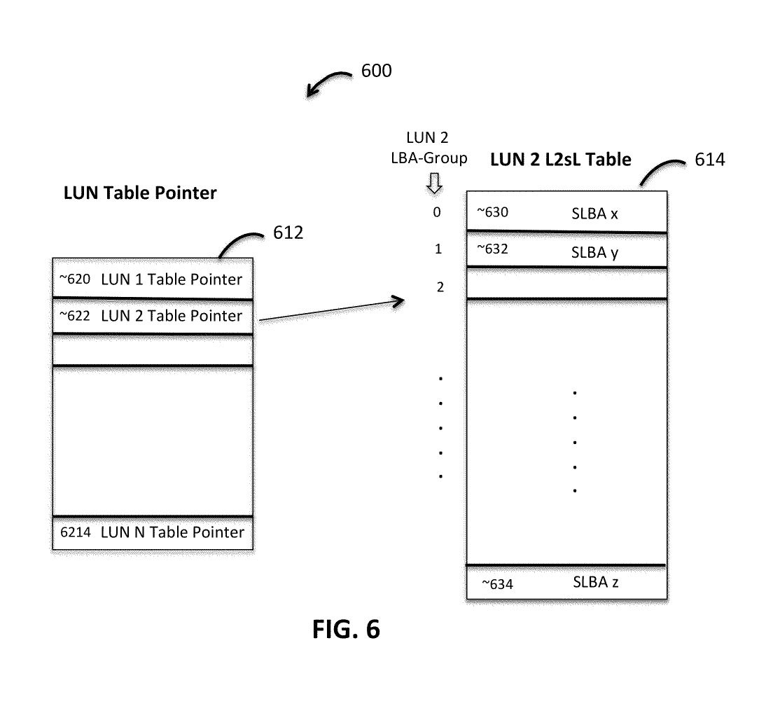

FIG. 6 shows exemplary tables 600, in accordance with another method and apparatus of the invention. Tables 600 are shown to include a LUN table pointer 612 and a LUN 2 L2sL table 614. The table 614 is an example of a mapping table discussed above. Also as previously discussed, the LUN table pointer 612 maintains a list of pointers with each pointer associated with a distinct LUN and pointing to the starting location of a distinct mapping table in the memory 20, which in this example is the table 614. Each LUN has its own L2sL table.

The table 614 maintains the location of SSD LBAs (or “SLBAs”) from the storage pool 26 associated with a LUN. For example, in row 630 of table 614, the SSD LBA ‘x’ (SLBA ‘x’) denotes the location of the LBA within a particular SSD of the storage pool assigned to the LUN 2 LBA-group. The SSD LBAs are striped across the bank of SSDs of the storage pool 26, further discussed in related U.S. patent application Ser. No. 14/040,280, by Mehdi Asnaashari, filed on Sep. 27, 2013, and entitled “STORAGE PROCESSOR MANAGING SOLID STATE DISK ARRAY”, which is incorporated herein by reference. Striping the LBA-groups across the bank of SSDs of the storage pool 26 allows near even wear of the flash memory devices of the SSDs and prolongs the life and increases the performance of the storage appliance.

In some embodiment of the invention, the size of the LBA-group or granularity of the LBA-groups (also herein referred to as “granularity”) is similar to the size of a page in flash memories. In another embodiment, the granularity is similar to the size of input/output (I/O) of commands that the storage system is expected to receive.

As used herein “storage pool free LBA-group” is synonymous with “storage pool free list” and “SSD free LBA group” is synonymous with “SSD free list”, and “size of LBA-group” is synonymous with “granularity of LBA-group” or “granularity” or “striping granularity”.

In another embodiment of the invention, the storage processor 10 maintains a SSD free list (also referred to as “unassigned SSD LBAs” or “unassigned SLBAs”) per SSD in the storage pool 26 instead of an aggregated storage pool free list. The SSD free list is used to identify free LBA-groups within each SSD of the storage pool 26. An entry from the head of each SSD free list creates a free stripe that will be used by the storage processor 10 for assignment of LUN LBA-groups to the storage pool LBA-groups. Once the storage processor 10 exhausts the current free stripe, it creates another free stripe for assignment thereafter.

To prevent uneven use of one or more of the SSDs, host write commands are each divided into multiple sub-commands based on the granularity or size of the LBA-group and each of the sub-commands is then mapped to a free LBA-group from each SSD free list using the free stripe therefore causing distribution of the sub-commands across the SSDs, such as PCIe SSDs.

When the storage processor 10 receives a write command associated with a LUN and the LUN's associated LBAs, it divides the command into one or more sub-commands based on the host LBA size (or number of LBAs) and the granularity or size of the LBA-group. Storage processor 10 determines if the LBA-groups associated with the sub-command have already been assigned to a LUN-group from the storage pool 26, or not. The LUN LBA-groups that have not been already assigned are associated with a LBA-group from a storage pool free list and the associated LUN mapping table 22 is updated accordingly to reflect this association. The LBAs, at the granularity or size of the LBA-groups, are used to index through the mapping table 22.

In one embodiment of the invention, once a LUN LBA-group is assigned to a storage pool LBA-group, it will not be reassigned to another storage pool LBA-group unless the LUN LBA-group is being removed from the LUN or the entire LUN is being removed. The storage processor 10 uses previously assigned storage pool LBA-group for any re-writes to the LUN LBA-group.

In another embodiment of the invention, in subsequent write accesses (re-writes) the storage processor 10, regardless of whether or not some of the LBA groups being written to have already been assigned to the LBA-groups from the storage pool, are all assigned to free LBA-groups from a free stripe. The storage pool LBA-groups associated with the LUN LBA-groups that had already been assigned are returned to the free list and added to the tail of the storage pool free LBA-group queue. Assigning all of LUN LBA-groups that are being re-written to free LBA-groups from free stripe, even if some of the LUN LBA-groups had already been assigned, causes striping of the sub-commands across a number of SSDs. This occurs even when the LUN LBA-groups are being re-written thereby causing substantially even wear of the SSDs and increasing the performance of the storage system 8.

In one embodiment of the invention, PCIe SSDs are PCIe NVMe SSDs and the storage processor 10 serves as NVMe host for the SSDs in the storage pool 26. The storage processor 10 receives a write command and corresponding LBAs form the host 12, divides the command into sub-commands based on the number LBAs and the size of LBA-group, with each sub-command having a corresponding LBA-group. The storage processor 10 then assigns a free LBA-group from the storage pool free list and assigns the free LBA-group to the LBA-group of each sub-command and creates the NVMe command structures for each sub-commands in the submission queues of corresponding PCIe NVMe SSDs.

In another embodiment of the invention, the storage processor 10 assigns a free LBA-group from the storage pool free stripe to the LBA-group of each sub-command therefore causing striping of the sub-commands across the SSDs of the storage pool 26. Storage processor 10 then creates the NVMe command structures for each sub-command in the submission queues of corresponding PCIe NVMe SSDs using the associated storage pool LBA-group as “Starting LBA” and the size of the LBA-group as “Number of Logical Blocks”.

In an embodiment of the invention, the storage processor 10 receives a write command and associated data form the host 12, divides the command into sub-commands and associates the sub-commands with a portion of the data (“sub-data”). A sub-data belongs to a corresponding sub-command. The data is stored in the memory 20.

In another embodiment of the invention, the storage processor 10 receives a read command and associated LBAs and LUN form the host 12, divides the read command into sub-commands based on the number of LBAs and the size of the LBA-group, with each sub-command having a corresponding LBA-group. The storage processor 10 then determines the storage pool LBA-groups associated with the LUN LBA-groups and creates the NVMe command structures for each sub-command and saves the same in the submission queues of corresponding PCIe NVMe SSDs. The NVMe command structures are saved in the submission queues using the associated storage pool LBA-group as the “Starting LBA” and size of the LBA-group as the “Number of Logical Blocks”. In the event no storage pool LBA-groups that are associated with the LUN LBA-groups is found, a read error is announced.

In some embodiments, host LBAs from multiple write commands are aggregated and divided into one or more sub-commands based on the size of LBA-group. In some embodiments, the multiple commands may have some common LBAs or consecutive LBAs. Practically, the host LBA of each command rather than the command itself is used to create sub-commands. An example of the host LBA is the combination of the starting LBA and the sector count. The host LBA of each write command is aggregated, divided into one or more LBAs based on the size of the LBA-group, with each divided LBA being associated with a sub-command. In an exemplary embodiment, the host LBA of a command is saved in the memory 20.

In other embodiment of the invention, storage processor 10 creates the NVMe command structures for each sub-command in the submission queues, such as the submission queues 24 of the corresponding SSDs. Each NVMe command structure points to a sub-data. By using NVMe PCIe SSDs to create the storage pool 26, the storage system or appliance manufacturer need not have to allocate resources to design its own proprietary SSDs for use in its appliance and can rather use off-the-shelf SSDs that are designed for high throughput and low latency. Using off-the-shelf NVMe PCIe SSDs also lowers the cost of manufacturing the storage system or appliance since multiple vendors are competing to offer similar products.

In yet another embodiment of the invention, the host data associated with a host write command is stored or cached in the non-volatile memory portion of the memory 20. That is, some of the non-volatile memory portions of the memory 20 is used as a write cache. In such a case, completion of the write command can be sent to the host once the data is in the memory 20, prior to dispatching the data to the bank of NVMe PCIe SSDs. This can be done because data is saved in a persistent (non-volatile) memory hence the write latency is substantially reduced allowing the host to de-allocate resources that were dedicated to the write command. Storage processor 10, at its convenience, moves the data from the memory 20 to the bank of NVMe PCIe SSDs. In the meanwhile, if the host wishes to access the data that is in the write cache but not yet moved to bank of NVMe PCIe SSDs, the storage processor 10 knows to access this data only from the write cache. Thus, host data coherency is maintained. In some embodiments of the invention, the storage processor may store enough host data in the non-volatile memory portion of memory 20 to fill at least a page of flash memory or two pages of flash memory in the case of dual plane mode operation.

In another embodiment of the invention, the SSD free list or storage pool free list, mapping tables, as well as the submission queues are maintained in the non-volatile portion of the memory 20. As a result, these queues and tables retain their values in the event of power failure. In another embodiment, the queues and/or table are maintained in a DRAM and periodically stored in the bank of SSDs (or storage pool) 26.

In yet another embodiment of the invention, when the storage processor 10 receives a write command, associated with a LUN whose LBA-groups has been previously written to, the storage processor 10 assigns new LBA-groups from the storage pool free list (to the LBA-groups being written to) and updates the mapping table accordingly. It returns the LBA-groups from the storage pool that were previously associated with the same LUN back to the tail of the storage pool free list for use thereafter.

In cases where a large storage space is employed, because a mapping table need be created for each LUN and each LUN could potentially reach the maximum LUN size allowed, there would be a large number of tables with each table having numerous entries or rows. This obviously undesirably increases the size of memory 20 and drives up costs. For example, in the case of 3,000 as the maximum number of LUNs allowed in the storage appliance, with each LUN having a maximum LBA size of 100,000 and a LBA-group size of 1,000, 3,000, mapping tables need to be maintained with each table having (100,000/1,000)=100 rows. The total memory size for maintaining these tables is 300,000 times the width of each entry or row. Some, if not most, of the 100 entries of the mapping tables are not going to be used since the size of most all the LUNs will not reach their maximum LUN size allowed in the storage appliance. Hence, most of the entries of the mapping table will contain ‘Null’ values.

To reduce the memory size, an intermediate table, such as an allocation table pointer is maintained. The size of this table is the maximum LUN size divided by an allocation size. The allocation size similar to the LBA-group size is determined by the manufacturer based on design choices and is typically somewhere between the maximum LUN size and the LBA-group size. For an allocation size of 10,000, the maximum number of rows for each allocation table pointer is (100,000/10,000)=10 and the number of rows for the mapping table associated with each allocation table pointer row is the maximum LUN size divided by the allocation size (10,000/1,000)=10. Storage processor 10 creates an allocation table having 10 rows when a LUN is created. The storage processor 10 then calculates the maximum number of allocation table pointer rows required for the LUN, based on the size of the LUN that is being created and the allocation size. The storage processor 10 creates a mapping table for each of the calculated allocation table pointer rows. For example, if the size of the LUN being created is 18,000 LBAs, the actual number of allocation table pointer rows required is the LUN size divided by the allocation size (18,000/10,000)=1.8 and rounded to 2 rows. As such, the storage processor need only create two mapping table of 10 rows, with each row associated with the two allocation table pointer entrees required for the LUN actual size. As such, the storage processor need not create a large mapping table initially to accommodate the maximum LUN size. It creates the mapping tables close to the actual size of the LUN and not the maximum size allowed for a LUN. Yet, the allocation table pointer has enough entries to accommodate the LUNs that do actually grow to the maximum size allowed but the size of the mapping table closely follows the actual size of the LUN.

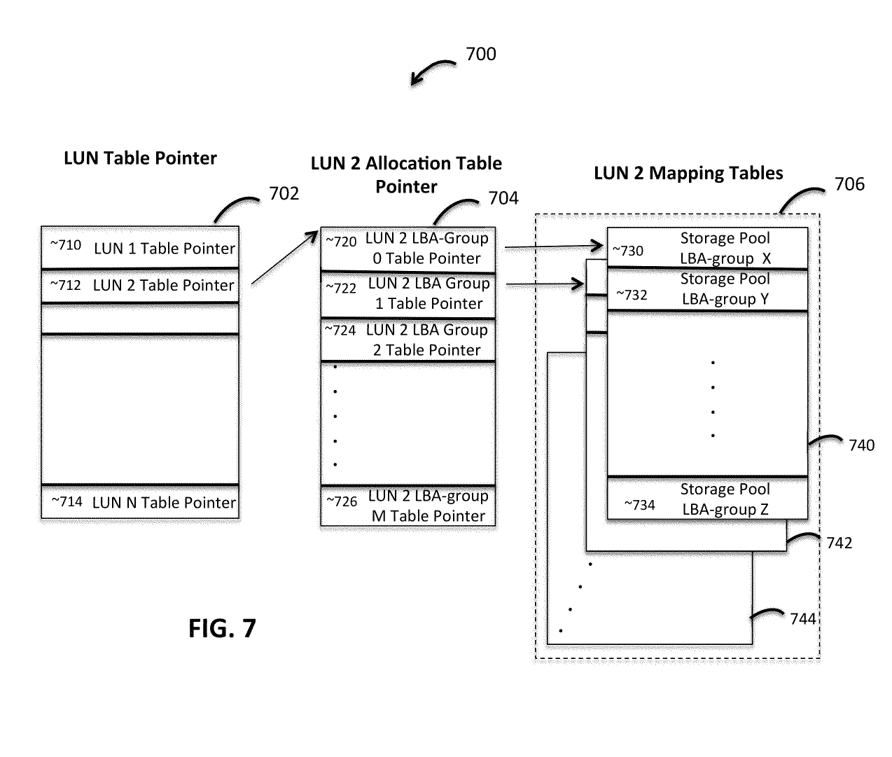

FIG. 7 shows an example of table 700 including an allocation table pointer 704. In FIG. 7, the tables 700 are the LUN table pointer 702, which is analogous to the LUN table pointer 202 of FIG. 2, a LUN 2 allocation table pointer 704, and a LUN 2 mapping tables 706. The pointers 712 of the LUN table pointer 702 points to a LUN 2 allocation table pointer 704 rather than the mapping table 706 and the entries of the LUN 2 allocation table pointer points to a smaller mapping tables 740, 742 thru 744 associated with the allocation table pointer entries. It is noted that the example of FIG. 7 uses LUN 2 for demonstration with the understanding that other LUNs may be employed. In an embodiment of the invention, the allocation table pointer 704 is maintained in the memory 20.

In FIG. 7, the pointer in row 712 of table 702 points to the LUN 2 allocation table pointer 704. Each row of the allocation table pointer 704 points to the starting address of the mapping table associated with that row. In the example of FIG. 7, all the mapping tables 740 through 744, being pointed to by the rows 720 through 726, are associated with LUN2. The content of row 720 is then used to point to a memory location of the mapping table 740 and the content of row 722 points to a memory location of the mapping table 742 and so on. The number of valid entrees in the allocation table pointer 704 is based on the actual size of the LUN and the granularity or size of the allocation tables and the number of mapping tables in 706 depends on the number of valid entries in the LUN 2 allocation table 704. Non-valid entries in the LUN 2 allocation table 704 will have ‘Null” value and will not have an associated mapping table.

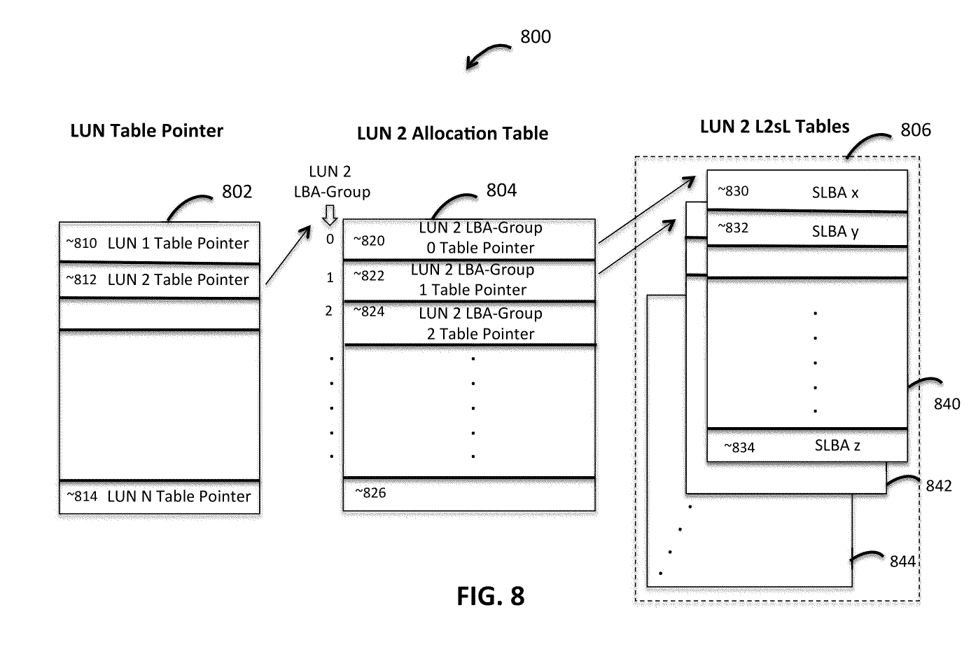

FIG. 8 shows exemplary tables 800, analogous to the tables 600 except that the tables 800 also include an allocation table. The tables 800 are shown to include a LUN table pointer 802, a LUN 2 allocation table 804, and a LUN 2 L2sL tables 806. Each of the entries of the table 802 points to the starting location of a particular LUN allocation table. In the example of FIG. 8, the entry in row 812 of the table 802 points to the starting location of LUN 2 allocation table pointer 804. Each entry in the rows 820-826 of the table 804 points to a starting location of the L2sL tables 840, 842 thru 844.

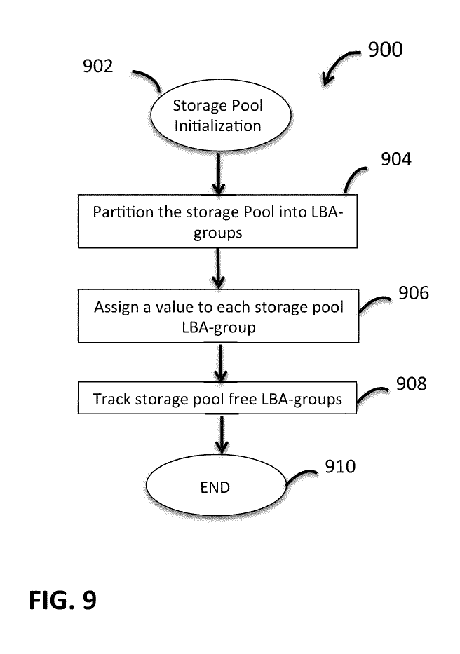

FIGS. 9-13 each show a flow chart of a process performed by the CPU subsystem 14, in accordance with methods of the invention.

FIG. 9 shows a flow chart 900 of the steps performed in initializing the storage pool 26, in accordance with a method of the invention. At 902, the storage pool 26, begins to be initialized. At step 904, the storage pool is partitioned into LBA-groups based on the granularity or size of the LBA-group. Next, at step 906, an index is assigned to each storage pool LBA-group with the index typically being the LUN LBA-group. At step 908, the available (or free) LBA-groups (storage pool free list) are tracked using queues, such as shown and discussed relative to FIG. 3 or using bit maps, such as shown and discussed relative to FIG. 4. The process ends at step 910.

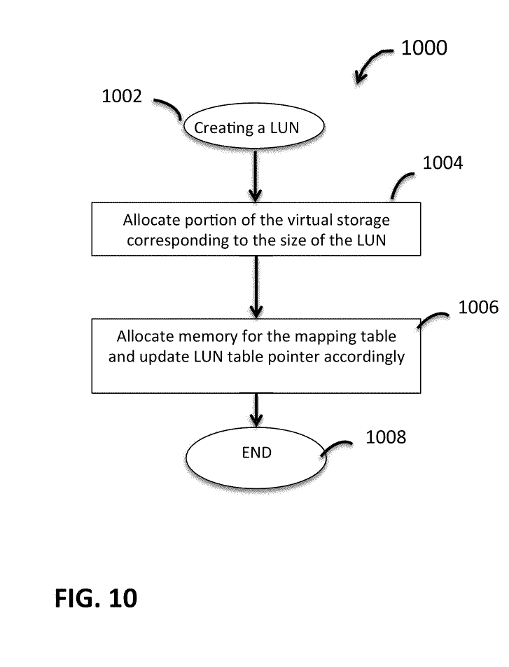

FIG. 10 shows a flow chart 1000 of the steps performed in creating LUNs, in accordance with a method of the invention. At 1002, the process of creating a LUN begins. At step 1004, the number of LBA-groups required for the LUN is determined by dividing the size of the LUN by the size of the LBA-group and portion of the virtual capacity 214 is allocated to the LUN and keep track of the unallocated portion of the virtual storage 214. At step 1006, memory is allocated for the mapping table and LUN table pointer is updated accordingly to point to the starting address of the table in the memory 20. The process ends at step 1008.

In some embodiment of the invention, the storage processor verifies the number of LBA-groups required for the LUN against the number of unallocated virtual storage and terminates the process prematurely if there are not enough unallocated virtual storage 214 to assign to the LUN being created.

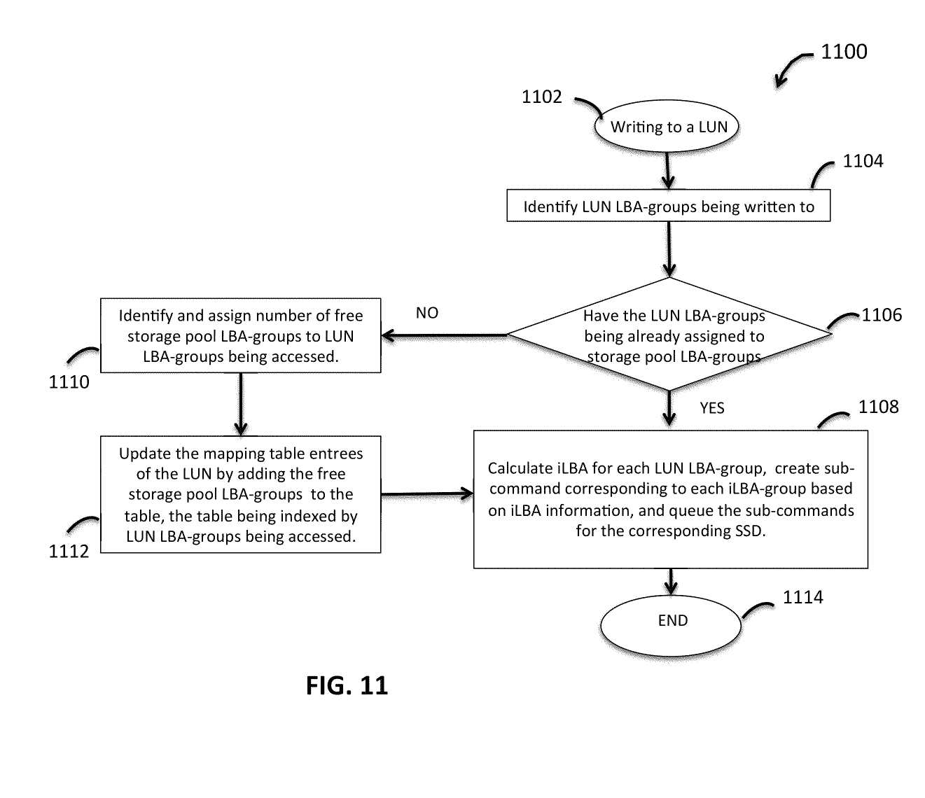

FIG. 11 shows a flow chart 1100 of the steps performed when writing to a LUN, in accordance with a method of the invention. At 1102, the process of writing to a LUN begins. At 1104, LUN LBA-groups that are being written to are identified. At 1106, a determination is made as to whether or not each of the LUN LBA-groups been written to already and have an associated storage pool LBA-groups or they've been written to for the first time. For each LBA-group that's been written to for the first time, the process continues to step 1110 where storage processor 10 identifies and assigns a storage pool free LBA-group from the storage pool free list to each of the LUN LBA groups that are been written to for the first time and the process continues to step 1112. In the case where the LUN LBA-groups were already assigned to each of the LBA-groups from the storage pool 26, the process continues to step 1108. At step 1112, the mapping table associated with the LUN is updated to reflect the association of the LUN LBA-groups been written to the storage pool LBA-groups. The storage pool LBA-groups associated with the LUN LBA-groups being written to for the first time are no longer free or available and are removed from the free list and the process continues to step 1108. At step 1108, the storage processor 10 derives the intermediary LBA (iLBA) for each LBA-group with iLBA being defined by the starting LBA and sector count for each sub-command. Storage processor 10 further uses the iLBA information to create write sub-commands corresponding to each LBA group. The process ends at 1114.

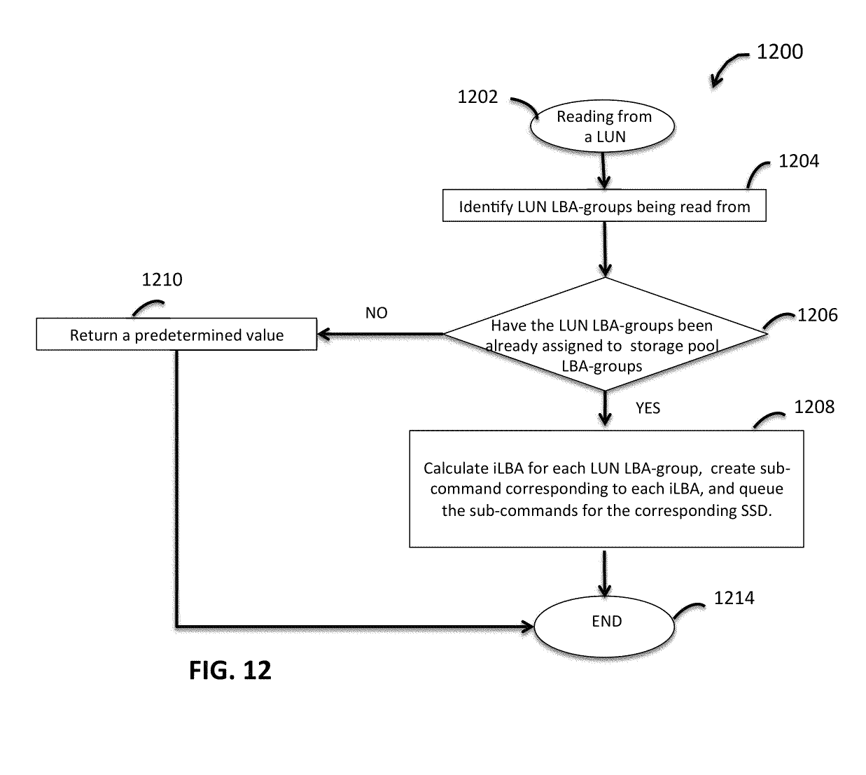

FIG. 12 shows a flow chart 1100 of the steps performed in reading from a LUN, in accordance with a method of the invention. At 1202, the process of reading a LUN begins. At 1204, LUN LBA-groups that are being read from are identified. At 1206, a determination is made as to whether or not each of the LUN LBA-groups being read has already been written to and has an associated storage pool LBA-groups. If ‘YES’, the process continues to step 1208 where the storage processor 10 derives the iLBA for each of the LUN LBA-groups that does have an associated storage pool LBA-group and create read sub-commands for each iLBA. If ‘NO’ at step 1206, the process continues to step 1210. A ‘NO’ at step 1206 signifies that the particular LUN LBA-group was not written to prior to being read from and therefore doesn't have an associated storage pool LBA-group. The storage processor 10 will returns a predetermined value (such as all ‘1’ or all ‘0’ for LUN LBA-group without an associated storage pool LBA-group. The storage processor does not derive iLBA nor create sub-commands for these LUN LBA-groups. The process ends at 1114.

In some embodiment of the invention, the storage processor 10 keeps track of number of LBA-groups in the storage pool free list and notifies the storage system administrator of the number of free LBA-groups in the storage pool having reached below a certain threshold. The administrator can then take appropriate actions to remedy the situation by either adding additional storage to the storage pool 26 or moving some of the LUNs to another storage system.

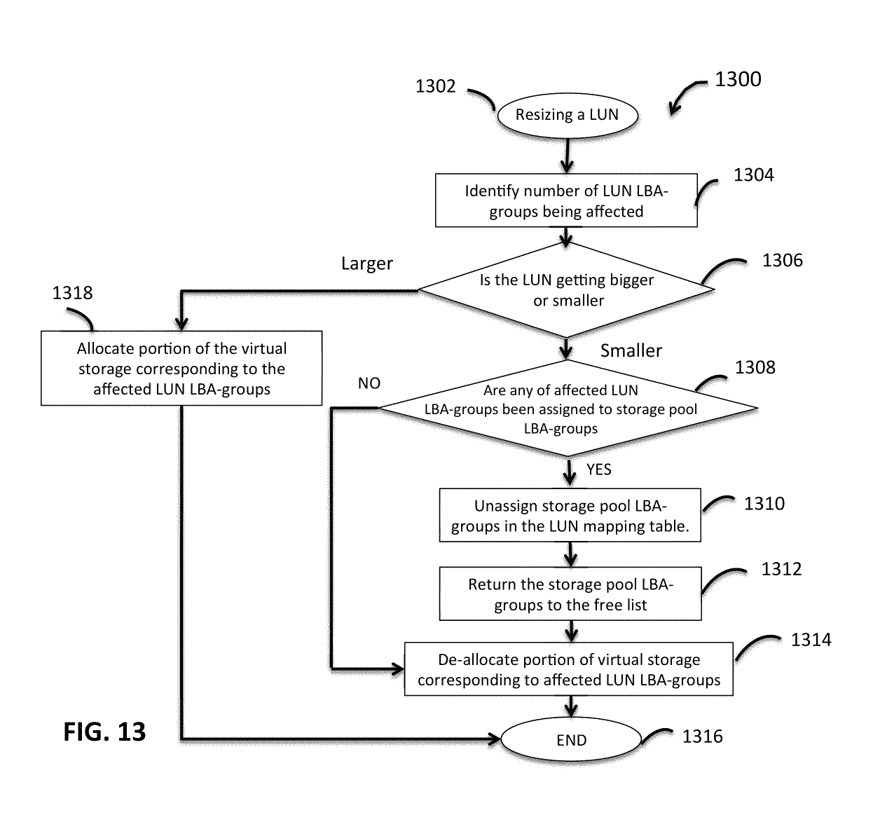

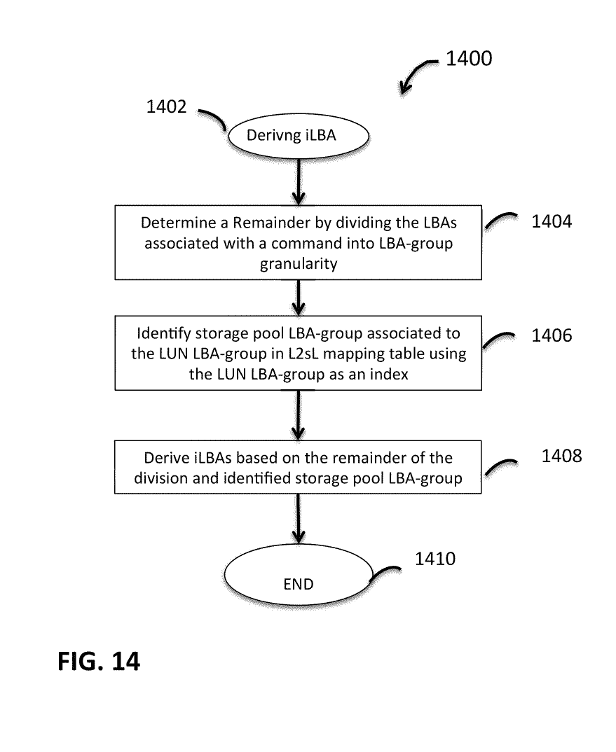

FIG. 13 shows a flow chart 1300 of the steps performed in resizing a LUN, in accordance with a method of the invention. At 1302, the process of resizing a LUN begins. At 1304, Number of LUN LBA-groups being affected is identified. Next at step 1306, a determination is made as to whether or not the LUN is to become larger or smaller. In the case of the latter, the process continues to step 1318 where the LUN LBA-groups being affected are allocated a portion of the storage pool 26 and the tally of unallocated portion of the virtual storage 214 is adjusted accordingly. The process ends at step 1316. If the LUN is getting ‘SMALLER” in step 1306, the process continues to step 1308 where a determination is made as to whether or not any of the affected LUN LBA-groups being removed has already been associated with any of the storage pool LBA-groups. If ‘YES’, the process moves to step 1310 where the storage processor 10 identifies each of the storage pool LBA-groups that have already been associated with the LUN LBA-groups being removed and unassigns them by updating the appropriate entries or rows of the mapping table corresponding to the LUN LBA-groups being removed. Next at step 1312, the identified storage pool LBA-groups are returned to the storage pool free list by being added to the tail of storage pool free LBA-group queue. Next at step 1314, the affected LUN LBA-group are added to the unallocated virtual storage and the process ends at step 1316. A ‘NO’ at step 1308 is ‘NO’ signifies that none of the LUN LBA-groups being removed have previously been assigned to the storage pool LBA-group and as such the process continues to step 1314 where the affected LUN LBA-group are added to the unallocated virtual storage and the process ends at step 1316.

In some embodiment of the invention, the storage processor 8 places a restriction on the maximum size of a LUN based on its resources. The storage processor 10 may check the new size of the LUN when the LUN is getting larger or when it is being created to determine whether or not the size does not exceed the maximum LUN size allowed by the storage system 8. In the case where the size of the LUN exceeds the maximum LUN size allowed, the storage processor terminates the LUN creation or LUN enlargement process.

In another embodiment, the storage processor 8 places a restriction on the maximum number of a LUNs allowed in the storage system based on its resources. The storage processor 10 checks the number of LUNs when a new LUN is created to determine whether or not the number of LUNs exceeds the maximum number of LUNs allowed by the storage system. In the case where the number of LUNs exceeds the maximum number allowed, the storage processor terminates the LUN creation process.

In yet another embodiment, the storage processor 10 may check the total size of all LUNs when a new LUN is created or becoming larger to determine whether or not the total size of all the LUNs exceeds the virtual space of the storage system 8. It is noted that in a thin provisioned storage system 8, the total size of all LUNs exceeds the size of the storage pool 26 in some cases by factor of 5 to 10 times. Storage processor 10 tracks the number of assigned LBA-groups, or alternatively the unassigned LBA-groups, within the storage pool and provides the mechanism to inform the user when the number of free LBA-groups within the storage pool is about to be exhausted.

FIG. 14 shows a flow chart 1400 of the steps performed in determining an iLBA for each LUN LBA-group in accordance with a method of the invention. The iLBA includes information such as the starting LBA of the storage pool 26 and sector count. At 1402, the iLBA calculation process starts. Next, at step 1404, the remainder of the division of the command LBAs into a LBA-group granularity is determined. At step 1406, the storage pool LBA group is identified by using the LUN LBA-group as an index into the L2sL mapping table. Next, at step 1408, an iLBA is derived by adding the remainder to the storage pool LBA-group and the process ends at step 1410.

Although the invention has been described in terms of specific embodiments, it is anticipated that alterations and modifications thereof will no doubt become apparent to those skilled in the art. It is therefore intended that the following claims be interpreted as covering all such alterations and modification as fall within the true spirit and scope of the invention.

What is claims is:

1. A method of thin provisioning in a storage system comprising:
communicating to a user a capacity of a virtual storage, the virtual storage capacity being substantially larger than that of a storage pool of solid state disks (SSDs) to present to the user an appearance of having more physical resources than are actually available in the storage pool of SSDs, the storage pool of SSDs having physical locations into which data from the user is to be stored, the virtual storage lacking physical locations within the SSDs;
creating logical unit numbers (LUNs) based on a granularity, each unit of LUN being defined by the size of the granularity and defining a LUN logical block address (LBA)-groups;
a storage processor, residing externally to the storage pool of SSDs, maintaining mapping tables in a memory residing externally to the storage pool of SSDs, each mapping table being for one or more LUNs and configured to store the relationship between storage pool LBA-groups and LUN LBA-groups;
the storage processor delaying allocating storage pool to the LUNs;
upon the user initiating writing of data ultimately written to the physical locations of the storage pool of SSDs assigning a free portion of the storage pool that is free and identified by a storage pool LBA-groups, to a LUN, identified by a LUN LBA-groups based on the granularity, wherein the assigning a free portion of the storage pool to a LUN is performed for each write operation after an initial write operation.

2. The method of thin provisioning, as recited in claim 1, wherein the portion of the storage pool defines a storage pool LBA-group and the storage pool LBA-group has a size that is the same as the size of one of the LUN LBA-groups.

3. The method of thin provisioning, as recited in claim 2, further including tracking the relationship of the LUN LBA-groups to the storage pool LBA-groups.

4. The method of thin provisioning, as recited in claim 2, further including identifying affected LUN LBA-groups being written to.

5. The method of thin provisioning, as recited in claim 4, further including identifying storage pool LBA-groups from a storage pool free list and assigning the identified storage pool LBA-groups to the affected LUN LBA-groups.

6. The method of thin provisioning, as recited in claim 4, wherein upon writing to a previously-assigned LUN LBA-group, assigning the previously-assigned LUN LBA-groups to a different storage pool LBA-group.

7. The method of thin provisioning, as recited in claim 4, wherein the assigning includes adding the storage pool LBA-groups to the mapping table.

8. The method of thin provisioning, as recited in claim 4, further including removing the identified storage pool LBA-groups from the storage pool free list.

9. The method of thin provisioning, as recited in claim 4, wherein the storage pool comprises one or more solid storage disks (SSDs) and further including maintaining a SSD free list consisting of free SSD LBA-groups for each of the one or more SSDs.

10. The method of thin provisioning, as recited in claim 9, further including a free stripe consisting of a free SSD LBA-group from each of the one or more SSDs.

11. The method of thin provisioning, as recited in claim 10, further including identifying storage pool LBA-groups from the free stripe and assigning the identified storage pool LBA-groups to the affected LUN LBA-groups.

12. The method of thin provisioning, as recited in claim 2, further including identifying affected LUN LBA-groups being removed, determining previously-assigned LUN LBA-groups to the storage pool LBA-groups and adding the already-assigned storage pool LBA-groups to the storage pool free list.

13. The method of thin provisioning, as recited in claim 12, wherein the tracking including unassigning the already assigned LUN LBA-groups from the mapping table.

14. The method of thin provisioning, as recited in claim 12, further including removing the already-assigned storage pool LBA-groups from the mapping table.

15. The method of thin provisioning, as recited in claim 1, further including generating the mapping table when a LUN is created.

16. The method of thin provisioning, as recited in claim 1, further including pointing to the mapping table using a LUN table pointer.

17. The method of thin provisioning, as recited in claim 1, further including removing the mapping table when a LUN is deleted.

18. The method of thin provisioning, as recited in claim 1, wherein the assigning is performed only when the LUN LBA-groups are being written to for the first time.

19. The method of thin provisioning, as recited in claim 1, further including a plurality of LUNs with each LUN having a size.

20. The method of thin provisioning, as recited in claim 19, wherein a total size of the LUNs does not exceed the virtual storage.

21. The method of thin provisioning, as recited in claim 19, wherein a total number of storage pool LBA-groups assigned to the LUNs does not exceed the storage pool.

22. The method of thin provisioning, as recited in claim 21, further including alerting through an alarm mechanism when the total number of assigned storage pool LBA-groups approaches a predetermined threshold.

23. The method of thin provisioning, as recited in claim 1, further including storing the mapping table in memory.

24. The method of thin provisioning, as recited in claim 23, wherein the memory includes non-volatile memory and storing the mapping table in the non-volatile memory.

25. A method of thin provisioning in a storage system comprising:
communicating to a user a capacity of a virtual storage, the virtual storage capacity being substantially larger than that of a storage pool;
receiving a write command, including logical block addresses (LBAs), the write command being associated with a logical unit number (LUN);
creating sub-commands from the write command based on a size of a LUN LBA-group, each of the sub-commands being associated with a LUN LBA-group; and
assigning the sub-commands to one or more solid state disks (SSDs) independently of the write command thereby causing striping across the one or more SSDs.

26. The method of thin provisioning, as recited in claim 25, further including maintaining a mapping table to track an association of the LUN LBA-group with a SSD of the one or more SSDs.

27. A method of thin provisioning in a storage system comprising:
communicating to a user a capacity of a virtual storage, the virtual storage capacity being substantially larger than that of a storage pool;
receiving a write command, including logical block addresses (LBAs), the write command being associated with a logical unit number (LUN);
creating sub-commands from the write command based on a size of a LUN LBA-group, each of the sub-commands being associated with a LUN LBA-group;
assigning the sub-commands to one or more solid state disks (SSDs)s; and
creating a NVMe command structure for each sub-command.

28. The method of thin provisioning as recited in claim 27, further including maintaining a mapping table to track an association of the LUN LBA-group with a SSD of the one or more SSDs.

29. A method of thin provisioning in a storage system comprising:
communicating to a user a capacity of a virtual storage, the virtual storage capacity being substantially larger than that of a storage pool of solid state disks (SSDs) to present to the user an appearance of having more physical resources than are actually available in the storage pool of SSDs, the storage pool of SSDs having physical locations into which data from the user is to be stored, the virtual storage lacking physical locations within the SSDs;
upon initiating writing of data to the storage pool, assigning a portion of the storage pool that is free and identified by storage pool LBA-groups, to a LUN, identified by LUN LBA-groups based on a granularity, each of the LUN LBA-groups corresponding to a storage pool LBA-groups groups, wherein the assigning a free portion of the storage pool to a LUN is performed for each write operation after an initial write operation,
further wherein the LUN LBA-groups assigned to storage pool LBA-groups appear to the host to identify a contiguous portion of the storage pool while the identified portion of the storage pool is actually physically, at least in part, in a non-contiguous portion of the storage pool.

30. The method of thin provisioning, as recited in claim 29, further including maintaining a mapping table to track an association of the LUN LBA-groups to the storage pool.

31. The method of thin provisioning, as recited in claim 1, further including upon subsequent accesses of the LUN LBA-groups that have already been related to storage pool LBA-groups, the storage processor identifying the LUN LBA-groups as being previously accessed LBA-groups and using their related storage pool LBA-group for further accesses.

32. The method of thin provisioning, as recited in claim 1, wherein the storage system having just enough resources to support the virtual storage capacity.
